(19) United States
(12) Patent Application Publication
(10) Pub. No.: US 2006/0224692 A1
(43) Pub. Date: Oct. 5, 2006

(54) Adhoc queries for services

(75) Inventor: Naveen Gupta, Sunnyvale, CA (US)

Correspondence Address: FLIESLER MEYER, LLP, FOUR EMBARCADERO CENTER, SUITE 400, SAN FRANCISCO, CA, 94111, US

(73) Assignee: BEA Systems, Inc., San Jose, CA (US)

(21) Appl. No.: 11/341,277

(22) Filed: Jan. 27, 2006

Related U.S. Application Data
(60) Provisional application No. 60/665,943, filed on Mar. 29, 2005.

(51) Int. Cl. G06F 15/16

(52) U.S. Cl. 709/217

(57) ABSTRACT

In accordance with embodiments of the present invention, there are provided mechanisms and methods for accessing a service on behalf of a requester and applying a query to results returned by the service. These mechanisms and methods applying queries to results returned by services make it possible for results from the service to be provided to the requester in a format conformed according to a filter provided by the requestor. This ability to access a service on behalf of a requestor and apply queries to results returned by the service makes it possible to attain improved usage from computing resources in a computer system because users can obtain results in a filtered form without the necessity of hard-coding all anticipated filtered forms into each service.

### CLAIM TO PRIORITY

The present application claims the benefit of:

U.S. Patent Application No. 60/665,943, entitled ADHOC QUERIES FOR SERVICES, by Naveen Gupta, filed Mar. 29, 2005 (Attorney Docket No. BEAS-01753US6).

### CROSS REFERENCE TO RELATED APPLICATIONS

The following commonly owned, co-pending United States patents and patent applications, including the present application, are related to each other. Each of the other patents/applications are incorporated by reference herein in its entirety:

U.S. Provisional Patent Application No. 60/665,908 entitled “LIQUID DATA SERVICES”, filed on Mar. 28, 2005, Attorney Docket No. BEAS 1753US0;

U.S. Provisional Patent Application No. 60/666,079 entitled “MODELING FOR DATA SERVICES”, filed on Mar. 29, 2005, Attorney Docket No. BEAS 1753US1;

U.S. Provisional Patent Application No. 60/665,768 entitled “USING QUERY PLANS FOR BUILDING AND PERFORMANCE TUNING SERVICES”, filed on Mar. 28, 2005, Attorney Docket No. BEAS 1753US2;

U.S. Provisional Patent Application No. 60/665,696 entitled “SECURITY DATA REDACTION”, filed on Mar. 28, 2005, Attorney Docket No. BEAS 1753US3;

U.S. Provisional Patent Application No. 60/665,667 entitled “DATA REDACTION POLICIES”, filed on Mar. 28, 2005, Attorney Docket No. BEAS 1753US4;

U.S. Provisional Patent Application No. 60/665,944 entitled “SMART SERVICES”, filed on Mar. 29, 2005, Attorney Docket No. BEAS 1753US5;

U.S. Provisional Patent Application No. 60/665,943 entitled “AD HOC QUERIES FOR SERVICES”, filed on Mar. 29, 2005, Attorney Docket No. BEAS 1753US6; and

U.S. Provisional Patent Application No. 60/665,964 entitled “SQL INTERFACE FOR SERVICES”, filed on Mar. 29, 2005, Attorney Docket No. BEAS 1753US7.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The current invention relates generally to accessing services on behalf of applications, and more particularly to a mechanism for applying queries to results returned by services.

### BACKGROUND

Increasingly, enterprises are looking for ways to simplify access and organization of Information Technology (IT) services. One mechanism for providing such IT simplification is Service Oriented Architecture (SOA). Application of SOA principles promises faster development cycles, increased reusability and better change tolerance for software components.

Unfortunately, enterprises that implement SOA often find that the start-up complexities of SOA delays, if not derails, the expected return on investment. While SOA simplifies the complexity of an IT environment, organizations lack sufficient experience with SOA technology required for a quick, trouble-free implementation. Compounding this experience gap, graphical tools for implementing SOA are not readily available, so that data services for use in SOA environments often must be hand-coded.

For enterprise-class portal and Web applications, for example, a majority of application development time can be spent on managing data access. A number of factors make data programming difficult and time-consuming, including a lack of flexibility in conventional data services. Because conventional data services are hand-coded, these services are capable of returning data only as the service has been defined to return it. Accordingly, such conventional services are known as “opaque” services. Users, however, desire variations in the data that the data services return. Unfortunately, conventional approaches require the designer of the service to anticipate all of the possible variations and provide users of the service with responses for each possible variation hard coded into SQL. Such conventional approaches are unable to support services that do not use SQL at all or that employ multiple databases.

### BRIEF DESCRIPTION OF THE DRAWINGS

FIGS. 1A-1B are functional block diagrams illustrating an example computing environment in which techniques for applying queries to results returned by services may be implemented in one embodiment.

FIG. 2A is an operational flow diagram illustrating a high level overview of a technique for applying queries to results returned by services of one embodiment of the present invention.

FIG. 2B is an operational flow diagram illustrating a high level overview of a client process operable with the technique for accessing a service illustrated in FIG. 2A.

FIG. 3 is an operational flow diagram illustrating a high level overview of another technique for applying queries to results returned by services and providing a filtered result set to a requestor according to the query in one embodiment of the present invention.

FIG. 4 is a screen shot illustrating a high level overview of a user interface operable with the technique for applying queries to results returned by services illustrated in FIG. 3.

FIG. 5 is a hardware block diagram of an example computer system, which may be used to embody one or more components of an embodiment of the present invention.

### DETAILED DESCRIPTION

In accordance with embodiments of the present invention, there are provided mechanisms and methods for accessing a service on behalf of a requestor and applying a query to results returned by the service. These mechanisms and methods applying queries to results returned by services make it possible for results from the service to be provided to the requester in a format conformed according to a filter provided by the requester. This ability to access a service on behalf of a requestor and apply queries to results returned by the service makes it possible to attain improved usage from computing resources in a computer system because users can obtain results in a filtered form without the necessity of hard-coding all anticipated filtered forms into each service.

In one embodiment, the invention provides a method for applying queries to results returned by services. One embodiment of the method includes receiving a request to access at least one service and a filter indicating a query to be applied to a result set returned by the at least one service. The at least one service is accessed on behalf of the requestor. A result set is received from the at least one service responsive to the accessing. A filtered result set is provided to the requestor by applying the filter to the result set received from the at least one service. In one embodiment, providing the filtered result set in includes forming the filtered result set by applying the query to the result set received from the service. Filtering the result set from the service can include one or more of filtering, alphabetizing, numerical ordering, sort ordering and truncating the result set.

As used herein, the term filtering is intended to be broadly construed to include any restriction, constraint or indication of a preferred format placed on results returned by a query. Some of the many types of filters available to requestors in various embodiments include, without limitation, filtered, alphabetized, numerically ordered, sort ordered, truncated, as well as other types of formatting in accordance with the requestor's instructions. For example, in a retail business environment, a requestor may place a filter such as “orders>100” onto a query for customer information, “getCustomer( )” in order to restrict returned results from the getCustomer function to only those customers having orders greater than 100. Similarly, a requester at a bank may specify “balance>100,000” to restrict a getCustomer query to return only high net worth customers. In a manufacturing example, a requestor in accounting may specify a filter “order date<=3^{rd} quarter” to see only results of a query for work in progress (WIP) residing on the factory floor. In the telecommunications field, a requestor desirous of viewing network nodes capable of handling a large bandwidth may specify a filter “bandwidth>1 Mps” for a query requesting node identities in the network in order to cause the server to eliminate any nodes not capable of supporting at least this bandwidth. These and other applications can be enabled by some of the many embodiments provided by the present invention. Accordingly, these examples are intended to be illustrative and not limiting of the many different applications enabled by various embodiments.

As used herein, the term service is intended to be broadly construed to include any application, program or process resident on one or more computing devices capable of providing services to a requestor or other recipient, including without limitation network based applications, web based server resident applications, web portals, search engines, photographic, audio or video information storage applications, e-Commerce applications, backup or other storage applications, sales/revenue planning, marketing, forecasting, accounting, inventory management applications and other business applications and other contemplated computer implemented services. The term result set is intended to be broadly construed to include any result provided by one or more services. Result sets may include multiple entries into a single document, file, communication or other data construct. As used herein, the term view is intended to be broadly construed to include any mechanism that provides a presentation of data and/or services in a format suited for a particular application, service, client or process. The presentation may be virtualized, filtered, molded, or shaped. For example, data returned by services to a particular application (or other service acting as a requestor or client) can be mapped to a view associated with that application (or service). Embodiments can provide multiple views of available services to enable organizations to compartmentalize or streamline access to services, increasing the security of the organization's IT infrastructure.

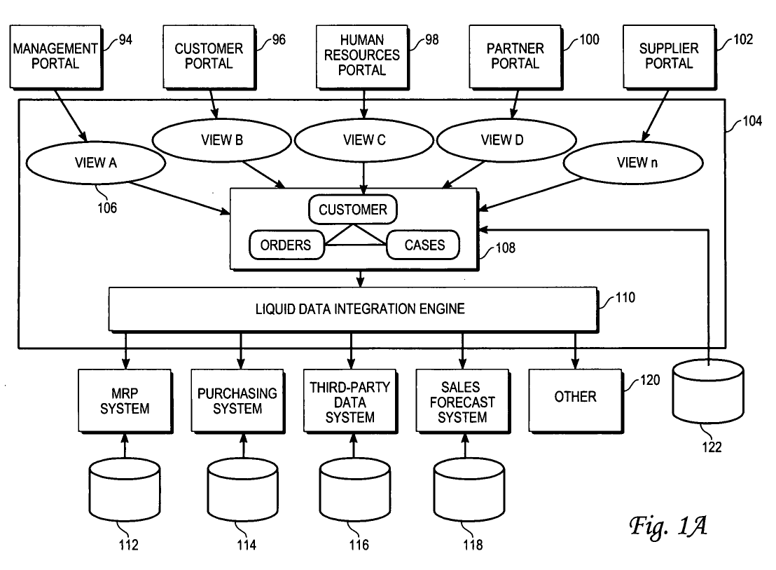

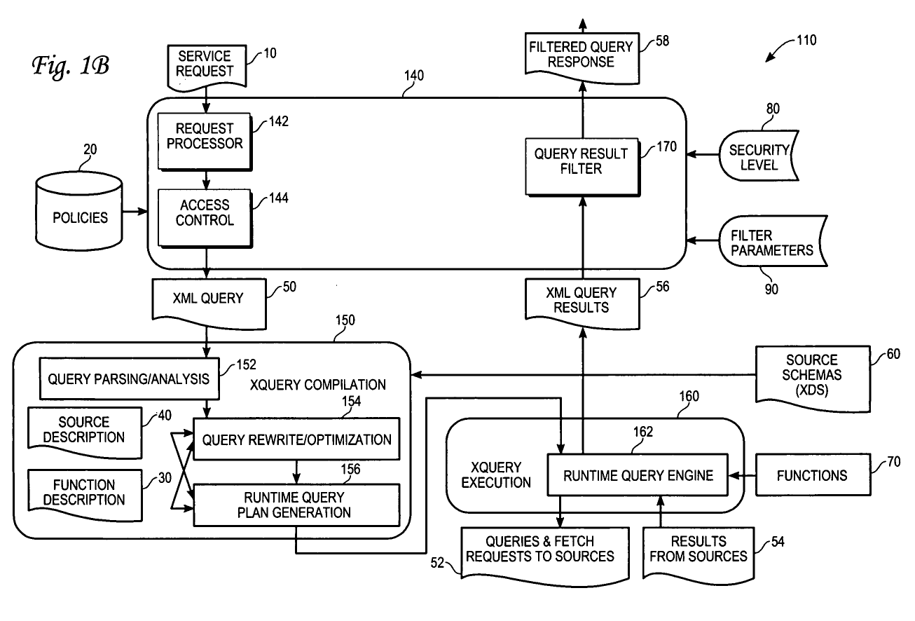

FIGS. 1A-1B are functional block diagrams illustrating an example computing environment in which techniques for data redaction may be implemented in one embodiment. As shown in FIG. 1A, a liquid data framework 104 is used to provide a mechanism by which a set of applications, or application portals 94, 96, 98, 100 and 102, can integrate with, or otherwise access in a tightly couple manner, a plurality of services. Such services may include a Materials Requirements and Planning (MRP) system 112, a purchasing system 114, a third-party relational database system 116, a sales forecast system 118 and a variety of other data-related services 120. Although not shown in FIG. 1A for clarity, in one embodiment, one or more of the services may interact with one or more other services through the liquid data framework 104 as well.

Internally, the liquid data framework 104 employs a liquid data integration engine 110 to process requests from the set of portals to the services. The liquid data integration engine 110 allows access to a wide variety of services, including data storage services, server-based or peer-based applications, Web services and other services capable of being delivered by one or more computational devices are contemplated in various embodiments. A services model 108 provides a structured view of the available services to the application portals 94, 96, 98, 100 and 102. In one embodiment, the services model 108 provides a plurality of views 106 that may be filtered, molded, or shaped views of data and/or services into a format specifically suited for each portal application 94, 96, 98, 100 and 102. In one embodiment, data returned by services to a particular application (or other service acting as a requestor or client) is mapped to the view 106 associated with that application (or service) by liquid data framework 104. Embodiments providing multiple views of available services can enable organizations to compartmentalize or streamline access to services, thereby increasing the security of the organization's IT infrastructure. In one embodiment, services model 108 may be stored in a repository 122 of service models. Embodiments providing multiple services models can enable organizations to increase the flexibility in changing or adapting the organization's IT infrastructure by lessening dependence on service implementations.

FIG. 1B is a high level schematic of a liquid data integration engine 110 illustrated in FIG. 1A with reference to one example embodiment. As shown in FIG. 1B, the liquid data integration engine 110 includes an interface processing layer 140, a query compilation layer 150 and a query execution layer 160. The interface layer 140 includes a request processor 142, which takes the request 10 and processes this request into an XML query 50. Interface layer 140 also includes access control mechanism 144, which determines based upon a plurality of policies 20 whether the client, portal application, service or other process making the request 10 is authorized to access the resources and services required to satisfy the request. Provided that the client, application, service or other process is authorized to make the request 10, the interface layer sends the XML query 50 to the query compilation layer 150.

Within the query compilation layer 150, a query parsing and analysis mechanism 152 receives the query 50 from the client applications, parses the query and sends the results of the parsing to a query rewrite optimizer 154. The query rewrite optimizer 154 determines whether the query can be rewritten in order to improve performance of servicing the query based upon one or more of execution time, resource use, efficiency or other performance criteria. The query rewrite optimizer 154 may rewrite or reformat the query based upon input from one or more of a source description 40 and a function description 30 if it is determined that performance may be enhanced by doing so. A runtime query plan generator 156 generates a query plan for the query provided by the query rewrite optimizer 154 based upon input from one or more of the source description 40 and the function description 30.

The query compilation layer 150 passes the query plan output from the runtime query plan generator 156 to a runtime query engine 162 in the query execution layer 160. The runtime query engine 162 is coupled with one or more functions 70 that may be used in conjunction with formulating queries and fetch requests to sources 52, which are passed on to the appropriate service(s). The service responds to the queries and fetch requests 52 with results from sources 54. The runtime query engine 162 of the query execution layer 160 translates the results into a format usable by the client or portal application, such as without limitation XML, in order to form the XML query results 56.

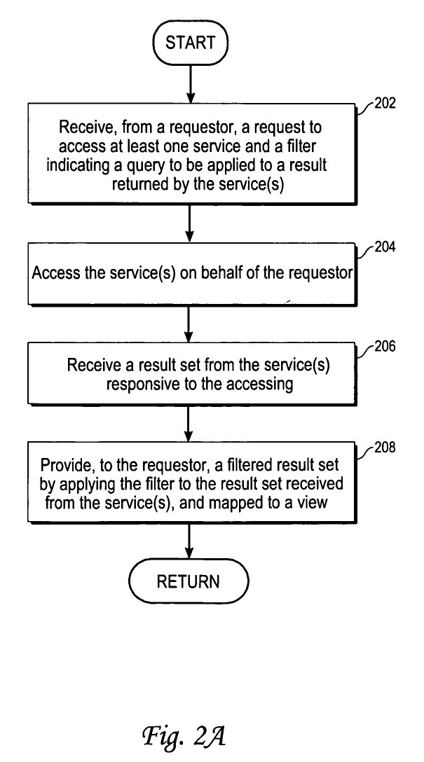

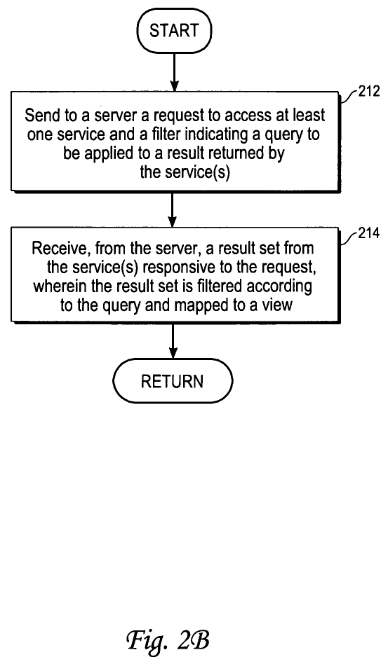

Before responses or results 56 are passed back to the client or portal application making the request, a query result filter 146 in the interface layer 140 determines based upon filter parameters 90 what portion of the results will be passed back to the client or portal application, forming a filtered query response 58. Although not shown in FIG. 1B for clarity, filter parameters 90 may accompany service request 10 in one embodiment. Further, query result filter 146 also determines based upon access policies implementing security levels 80 what portions of the filtered query response 58 a requestor is permitted to access and may redact the filtered query response accordingly. Although not shown in FIG. 1B for clarity, access policies implementing security levels 80 may be stored with policies 20 in one embodiment. Techniques for providing a filtered result set to the requester implemented by query result filter 170 will be described below in greater detail with reference to FIGS. 2A-2B. When properly formed, the response is returned to the calling client or portal application.

In one embodiment, result sets are returned to the client in a format specified by Service Data Objects (SDO). SDO is a specification published jointly by BEA and IBM (submitted as a Java Specification Request as JSR 235) that defines a data programming architecture and an Application Programming Interface (API). In embodiments employing SDO, Java clients associated with portal applications 94, 96, 98, 100 and 102 of FIG. 1A access data services 112-120 via liquid data framework 104 through SDO. When a Java or other client calls a data service read function, it gets data back in the form of a data object. A data object is the basic unit of the SDO model.

In one embodiment, SDO coupled with liquid data framework 104 provides data updates that are seamless to the client—the client simply calls an update function on changed data. The rest of the processing is taken care of by the Liquid Data integration engine 110, which includes deployed services, SDO exits, a mediator, a query engine and the like. In this embodiment, a process for making updates to data will now be described. When one of its read functions is called, a data service 112-120 of FIG. 1A returns an SDO data object to the client application 94, 96, 98, 100 and 102 of FIG. 1A. The application may be a Java application, a portal, JSP-based web application, business process model, or many other things. The application 94, 96, 98, 100 and 102 of FIG. 1A may modify values in the data object, for example, adding, deleting, or inserting values. Changes are tracked in a change log, a list of value changes that is associated with the data object. When ready, the client application 94, 96, 98, 100 and 102 of FIG. 1A submits the changes back to Liquid Data framework 104. Liquid Data framework 104 determines where the data came from. It also checks for custom update modules; extensions to the update process, for example, to apply custom accounting logic to the update or to propagate the update. The Liquid Data framework 104 then propagates the changes back to the data sources associated with services 112-120 in FIG. 1A. Accordingly, by insulating the client from the complexity of data update logic as described above, some embodiments can save substantial amounts of the time required to develop portals or similar web applications.

FIG. 2A is an operational flow diagram illustrating a high level overview of a technique for applying queries to results returned by services of one embodiment of the present invention. The technique for applying queries to results returned by services shown in FIG. 2A is operable with an application sending data, such as Materials Requirements and Planning (MRP) system 112, an purchasing system 114, a third-party relational database system 116, sales forecast system 118, or a variety of other data-related services 120 of FIG. 1A, for example. As shown in FIG. 2A, a request to access a service and a filter indicating a query to be applied to a result returned by the service are received (block 202). The service is accessed on behalf of the requestor (block 204). A result set is received from the service responsive to the request (block 206). A filtered result set is provided to the requestor by applying the filter to the result set received from the service (block 208). The liquid data framework 104 maps the result set to a view associated with the requestor. In one embodiment, providing the filtered result set in includes forming the filtered result set by applying the query to the result set received from the service. Filtering the result set from the service can include one or more of filtering, alphabetizing, numerical ordering, sort ordering and truncating the result set in accordance with the filter. In one embodiment, the method illustrated by blocks 202-208 may be advantageously disposed in the interface processing layer 140, query compilation layer 150 and query execution layer 160 of FIG. 1B.

FIG. 2B is an operational flow diagram illustrating a high level overview of a client process operable with the technique for accessing a service illustrated in FIG. 2A. The technique for receiving filtered data shown in FIG. 2B is operable with an application sending data, such as applications application 94, 96, 98, 100 and 102 of FIG. 1A, for example or a service, such as Materials Requirements and Planning (MRP) system 112, an purchasing system 114, a third-party relational database system 116, sales forecast system 118, or a variety of other data-related services 120 of FIG. 1A. As shown in FIG. 2B, a request to access a service and a filter indicating a query to be applied to a result returned by the service is sent to a server (block 212). A result set is received from the server responsive to the request (block 214). The result set is filtered according to the query and mapped to a view associated with a requester.

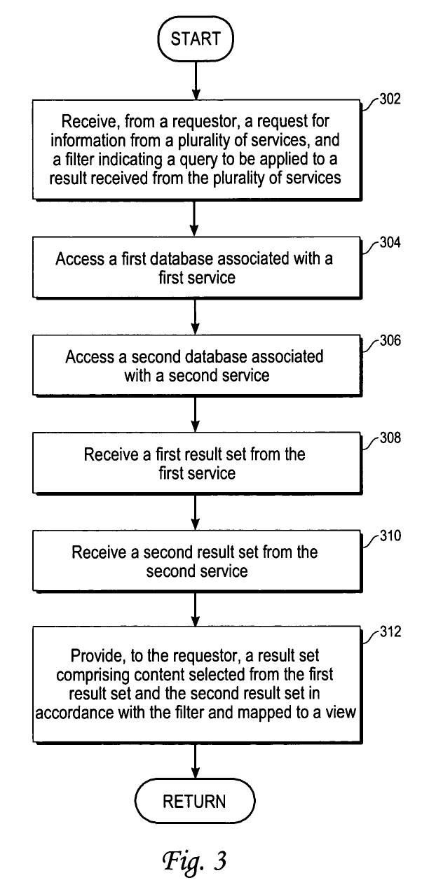

FIG. 3 is an operational flow diagram illustrating a high level overview of another technique for accessing services and applying filtering to a result set according indications received from a requestor in one embodiment of the present invention. The technique for accessing a service shown in FIG. 3 is operable with an application sending data, such as the applications described above with reference to FIG. 2A. As shown in FIG. 3, a request for information from a plurality of services, and a filter indicating a query to be applied to a result received from the plurality of services are received from a requestor (block 302). A first database associated with a first service is accessed (block 304). A second database associated with a second service is accessed (block 306). A first result set is received from the first service (block 308). A second result set is received from the second service (block 310). A result set comprising content selected from the first result set and the second result set is provided to the requestor in accordance with the filter (block 312) and mapped to a view associated with the requester. In one embodiment, at least one of the first database and the second database is a non-SQL format database.

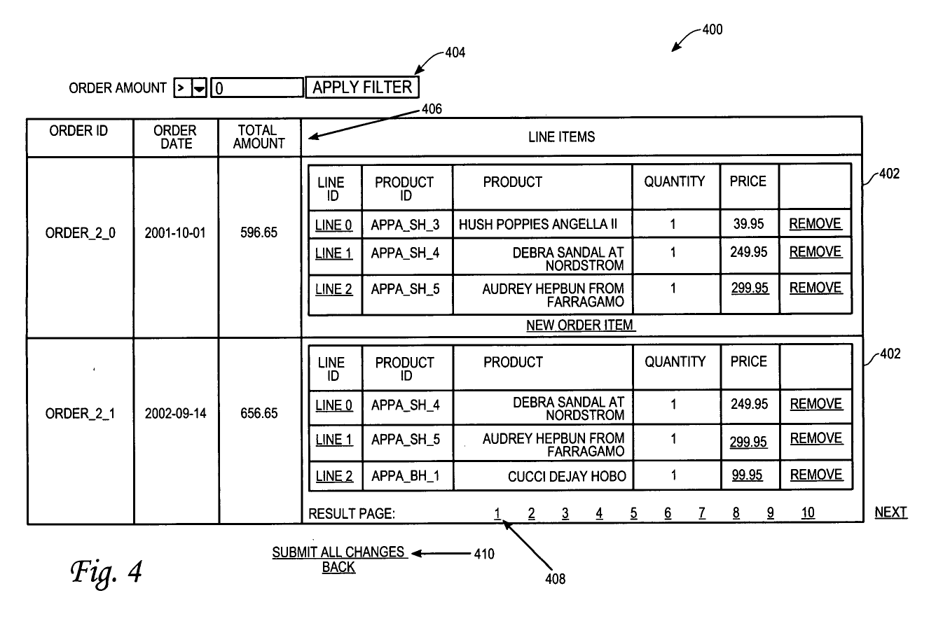

FIG. 4 is a screen shot illustrating a high level overview of a user interface operable with the techniques for accessing a service illustrated in FIGS. 2A-3. As shown in FIG. 4, screen 400 includes a viewing area 402 in which results from one or more data services may be displayed. A requestor may enter an amount to filter results by and select the apply filter button 404 in order to filter on a data service. The processing of FIGS. 2A-3 will apply this input to ensure that results from the one or more services are filtered according to the amount entered by the requester. Similarly, the requestor may select one or more column headings 406 in order to cause the processing of FIGS. 2A-3 to sort the results from the service(s) by the field(s) corresponding to the selected column heading. Screen 400 also includes other mechanisms for controlling the results of services, such as pagination or truncation selection buttons 408 and a “submit all changes” button 410 to invoke batched updates to the results returned by the services.

The operation of one embodiment will be described in further detail with reference to examples of usage scenarios. In the illustrated embodiment, a client makes queries about Customers, each having 0 or more nested Orders in XML format. Using techniques provided herein, the client is able to obtain results from services in a desired form without the necessity of becoming fluent in preparing XQuery statements.

The client instantiates an instance of an XQueryFilter object defined in Table 1 that can be passed to an XQuery engine (along with Function Name defined in XDS).

TABLE 1
XQueryFilter object

| | |
|---|---|
| 1 | public class XQueryFilter |
| 2 | extends java.lang.Object |
| 3 | implements java.io.Serializable |

The XQuery engine processes these filters/orderderby list, generates and executes an appropriate XQuery. This approach is especially useful in situations where an XML Data Service (XDS) returns a document that contains nested objects and the user wants to see different views based on certain conditions. For example, if the returned document is:
(CUSTOMERS/CUSTOMER/ORDER), i.e., CUSTOMERS is the top-level document element.

CUSTOMER is a sequence inside CUSTOMERS that can be repeated. ORDER is a sequence inside CUSTOMER that can be repeated. Table 2 illustrates an example XML data for Customers, having nested Orders:

TABLE 2
Customers with nested orders

| | |
|---|---|
| 1 | <customers> |
| 2 | <customer id=“CUSTOMER_1”> |
| 3 | <name>JOHN_1</ name> |
| 4 | <order id=“ORDER_ID_1_0”> |
| 5 | <TOTAL_ORDER_AMOUNT>1000 |
| | </TOTAL_ORDER_AMOUNT> |
| 6 | </order> |
| 7 | <order id=“ORDER_ID_1_1”> |
| 8 | <TOTAL_ORDER_AMOUNT>1500 |
| | </TOTAL_ORDER_AMOUNT> |
| 9 | </order> |
| 10 | </customer> |
| 11 | <customer id=“CUSTOMER_10”> |
| 12 | <name>JOHN_10</name> |
| 13 | <order id=“ORDER_ID_10_0”> |
| 14 | <TOTAL_ORDER_AMOUNT>1000 |
| | </TOTAL_ORDER_AMOUNT> |
| 15 | </order> |
| 16 | </customer> |
| 17 | <customer id=“CUSTOMER_2”> |
| 18 | <name>JOHN_2</ name> |
| 19 | <order id=“ORDER_ID_2_0”> |
| 20 | <TOTAL_ORDER_AMOUNT>1000 |
| | </TOTAL_ORDER_AMOUNT> |
| 21 | </order> |
| 22 | <order id=“ORDER_ID_2_1”> |
| 23 | <TOTAL_ORDER_AMOUNT>1500 |
| | </TOTAL_ORDER_AMOUNT> |
| 24 | </order> |
| 25 | <order id=“ORDER_ID_2_2”> |
| 26 | <TOTAL_ORDER_AMOUNT>2000 |
| | </TOTAL_ORDER_AMOUNT> |
| 27 | </order> |
| 28 | </customer> |
| 29 | </customers> |

A hypothetical user may want to see large orders (i.e. TOTAL₁₃ORDER₁₃AMOUNT>1000). Four example cases in which the user can filter service data having the XML schema provided in Table 2 will be described:
1. Only CUSTOMER objects that have at least one large order and view All ORDER objects for such CUSTOMER
2. All CUSTOMER objects but Only Large ORDER objects
3. Only CUSTOMER objects that have at least one large order and view only Large ORDER objects (basically 1 & 2)
4. Only CUSTOMER objects that have only large orders (i.e. ORDER₁₃AMOUNT>1000).

Instead of writing XQuery for each of these 4 cases, the user need only pass the XQueryFilter object as parameter when invoking a service via the liquid data framework 104 of FIG. 1A, for example.

In a first case scenario, the user would like to filter based upon customers (top level object) only, by applying a query to the lower level object (i.e. order/TOTAL₁₃ORDER₁₃AMOUNT). All Customers that have at least one large order will be returned with all orders (i.e. orders will not be filtered). An example of adding the filter at the client is depicted in Table 3:

TABLE 3
Client AddFilter to filter only customers

| | |
|---|---|
| 1 | XQueryFilter filter = new XQueryFilter( ); |
| 2 | filter.addFilter(“CUSTOMER”,“CUSTOMER/ORDER/ |
| | ORDER_AMOUNT”,“> |
| 3 | ”,“1000”); |

The corresponding XQuery generated for the client's addfilter invocation in Table 3 is shown in Table 4:

TABLE 4
Query for filter only customers

| | |
|---|---|
| 1 | For $c in document(Customers)/Customers/Customer |
| 2 | Where some $o in $c/order satisfies |
| | $o/TOTAL_ORDER_AMOUNT > 1000 |
| 3 | Return $c |

This query will produce the output shown in Table 5. Note that CUSTOMER₁₃10, lines 11-16 of Table 2, is not returned in the output of Table 5, because there are no orders larger than 1000 associated with CUSTOMER₁₃10. Also note that no orders were filtered even through orders with less than or equal to 1000 units exist in the data returned by the service.

TABLE 5
Output for filter only customers

| | |
|---|---|
| 1 | <customers> |
| 2 | <customer id=“CUSTOMER_1”> |
| 3 | <name>JOHN_1</ name> |
| 4 | <order id=“ORDER_ID_1_0”> |
| 5 | <TOTAL_ORDER_AMOUNT>1000 |
| | </TOTAL_ORDER_AMOUNT> |
| 6 | </order> |
| 7 | <order id=“ORDER_ID_1_1”> |
| 8 | <TOTAL_ORDER_AMOUNT>1500 |
| | </TOTAL_ORDER_AMOUNT> |
| 9 | </order> |
| 10 | </customer> |
| 11 | <customer id=“CUSTOMER_2”> |
| 12 | <name>JOHN_2</ name> |
| 13 | <order id=“ORDER_ID_2_0”> |
| 14 | <TOTAL_ORDER_AMOUNT>1000 |
| | </TOTAL_ORDER_AMOUNT> |
| 15 | </order> |
| 16 | <order id=“ORDER_ID_2_1”> |
| 17 | <TOTAL_ORDER_AMOUNT>1500 |
| | </TOTAL_ORDER_AMOUNT> |
| 18 | </order> |
| 19 | <order id=“ORDER_ID_2_2”> |
| 20 | <TOTAL_ORDER_AMOUNT>2000 |
| | </TOTAL_ORDER_AMOUNT> |
| 21 | </order> |
| 22 | </customer> |
| 23 | </customers> |
| 24 | |

In a second case scenario, the user would like to see only larger orders and only those customers that have these orders. An example of adding the filter at the client for this scenario is depicted in Table 6:

TABLE 6
Client AddFilter for only larger orders and only those customers with these
orders

| | |
|---|---|
| 1 | XQueryFilter filter = new XQueryFilter( ); |
| 2 | filter.addFilter(“CUSTOMER”, |
| | “CUSTOMER/ORDER/ORDER_AMOUNT”,“> |
| 3 | ”,“1000”); |

Table 7 illustrates corresponding XQuery generated for the client's addfilter shown in Table 6:

TABLE 7
Query for filter only larger orders and only those customers
with these orders

| | |
|---|---|
| 1 | For $c in document(Customers)/Customers/Customer |
| 2 | Where some $o in $c/order satisfies |
| | $o/TOTAL_ORDER_AMOUNT > 1000 |
| 3 | Return |
| 4 | <customer id = {$c/@id}> |
| 5 | {$c/name} |
| 6 | {$c/othet customer elements except order} |
| 7 | { |
| 8 | For $ord in $c/order |
| 9 | Where $ord/TOTAL_ORDER_AMOUNT > 1000 |
| 10 | Return $ord |
| 11 | } |
| 12 | </customer> |
| 13 | |

This query will produce the output shown in Table 8. Note that, in Table 8, the output has been filtered by the nested object (order) as well as by the first level object (customer).

TABLE 8
Output for filter only larger orders and only those customers
with these orders

| | |
|---|---|
| 1 | <customers> |
| 2 | <customer id=“CUSTOMER_1”> |
| 3 | <name>JOHN_1</ name> |
| 4 | <order id=“ORDER_ID_1_1”> |
| 5 | <TOTAL_ORDER_AMOUNT>1500 |
| | </TOTAL_ORDER_AMOUNT> |
| 6 | </order> |
| 7 | </customer> |
| 8 | <customer id=“CUSTOMER_2”> |
| 9 | <name>JOHN_2</ name> |
| 10 | <order id=“ORDER_ID_2_1”> |
| 11 | <TOTAL_ORDER_AMOUNT>1500 |
| | </TOTAL_ORDER_AMOUNT> |
| 12 | </order> |
| 13 | <order id=“ORDER_ID_2_2”> |
| 14 | <TOTAL_ORDER_AMOUNT>2000 |
| | </TOTAL_ORDER_AMOUNT> |
| 15 | </order> |
| 16 | </customer> |
| 17 | </customers> |
| 18 | |

In a third case scenario, the user would like to see all customers (i.e. no filter at top level), however, only large orders. In other words, there should be nothing displayed for customers who do not have any large orders. An example of adding the filter at the client for this scenario is depicted in Table 9:

TABLE 9
Client AddFilter for filter only larger orders but show all customers

| | |
|---|---|
| 1 | XQueryFilter filter = new XQueryFilter( ); |
| 2 | filter.addFilter(“CUSTOMER/ORDER”,“CUSTOMER/ORDER/ |
| | ORDER_AMOUNT”,“>”,“1000”); |
| 3 | |

Table 10 illustrates a generated XQuery corresponding to Table 9:

TABLE 10
Query for filter only larger orders but show all customers

| | |
|---|---|
| 1 | For $c in document(Customers)/Customers/Customer |
| 2 | Return |
| 3 | <customer id = {$c/@id}> |
| 4 | {$c/name} |
| 6 | {$c/othet customer elements except order} |
| 7 | { |
| 8 | For $ord in $c/order |
| 9 | Where $ord/TOTAL_ORDER_AMOUNT > 1000 |
| 10 | Return $ord |
| 11 | } |
| 12 | |

This query will produce the output shown in Table 11. Note that, in lines 8-10 of Table 11, the output will include CUSTOMER₁₃10, but no orders for CUSTOMER₁₃10 are shown because no large orders (i.e.,>1000) are associated with this customer in the data schema in Table 2.

TABLE 11
Output for filter only larger orders but show all customers

| | |
|---|---|
| 1 | <customers> |
| 2 | <customer id=“CUSTOMER_1”> |
| 3 | <name>JOHN_1</ name> |
| 4 | <order id=“ORDER_ID_1_1”> |
| 5 | <TOTAL_ORDER_AMOUNT>1500 |
| | </TOTAL_ORDER_AMOUNT> |
| 6 | </order> |
| 7 | </customer> |
| 8 | <customer id=“CUSTOMER_10”> |
| 9 | <name>JOHN_10</name> |
| 10 | </customer> |
| 11 | <customer id=“CUSTOMER_2”> |
| 12 | <name>JOHN_2</ name> |
| 13 | <order id=“ORDER_ID_2_1”> |
| 14 | <TOTAL_ORDER_AMOUNT>1500 |
| | </TOTAL_ORDER_AMOUNT> |
| 15 | </order> |
| 16 | <order id=“ORDER_ID_2_2”> |
| 17 | <TOTAL_ORDER_AMOUNT>2000 |
| | </TOTAL_ORDER_AMOUNT> |
| 18 | </order> |
| 19 | </customer> |
| 20 | </customers> |
| 21 | |

In a fourth case scenario, the user would like to see only those customers that have exclusively large orders. An example of adding the filter at the client for this scenario is depicted in Table 12:

TABLE 12
Client AddFilter for filter only larger orders but show all customers

| | |
|---|---|
| 1 | XQueryFilter filter = new XQueryFilter( ); |
| 2 | filter.addFilter(“CUSTOMER/ORDER”, |
| | “CUSTOMER/ORDER/ORDER_AMOUNT”,“>”,“1000”); |
| 3 | |

Table 13illustrated an XQuery generated for the addfilter case shown in Table 12:

TABLE 13
Query for filter only those customers that have only large orders

| | |
|---|---|
| 1 | For $c in document(Customers)/Customers/Customer |
| 2 | Where every $o in $c/order satisfies |
| 3 | $o/TOTAL_ORDER_AMOUNT > 1000 |
| 4 | Return $c |
| 5 | |

In this example, since there are no customers that have only large orders in the data in Table 2, the above query will return an empty set. While the foregoing example illustrates the use of techniques for filtering the information returned by a service prior to providing the information to the user, the techniques provided by the present invention are not nearly so limited, and can provide other forms of customizing, ordering or truncating data provided by services.

In other aspects, the invention encompasses in some embodiments, computer apparatus, computing systems and machine-readable media configured to carry out the foregoing methods. In addition to an embodiment consisting of specifically designed integrated circuits or other electronics, the present invention may be conveniently implemented using a conventional general purpose or a specialized digital computer or microprocessor programmed according to the teachings of the present disclosure, as will be apparent to those skilled in the computer art.

Appropriate software coding can readily be prepared by skilled programmers based on the teachings of the present disclosure, as will be apparent to those skilled in the software art. The invention may also be implemented by the preparation of application specific integrated circuits or by interconnecting an appropriate network of conventional component circuits, as will be readily apparent to those skilled in the art.

The present invention includes a computer program product which is a storage medium (media) having instructions stored thereon/in which can be used to program a computer to perform any of the processes of the present invention. The storage medium can include, but is not limited to, any type of rotating media including floppy disks, optical discs, DVD, CD-ROMs, microdrive, and magneto-optical disks, and magnetic or optical cards, nanosystems (including molecular memory ICs), or any type of media or device suitable for storing instructions and/or data.

Stored on any one of the computer readable medium (media), the present invention includes software for controlling both the hardware of the general purpose/specialized computer or microprocessor, and for enabling the computer or microprocessor to interact with a human user or other mechanism utilizing the results of the present invention. Such software may include, but is not limited to, device drivers, operating systems, and user applications.

Included in the programming (software) of the general/specialized computer or microprocessor are software modules for implementing the teachings of the present invention, including, but not limited to providing mechanisms and methods for applying queries to results returned by services as discussed herein.

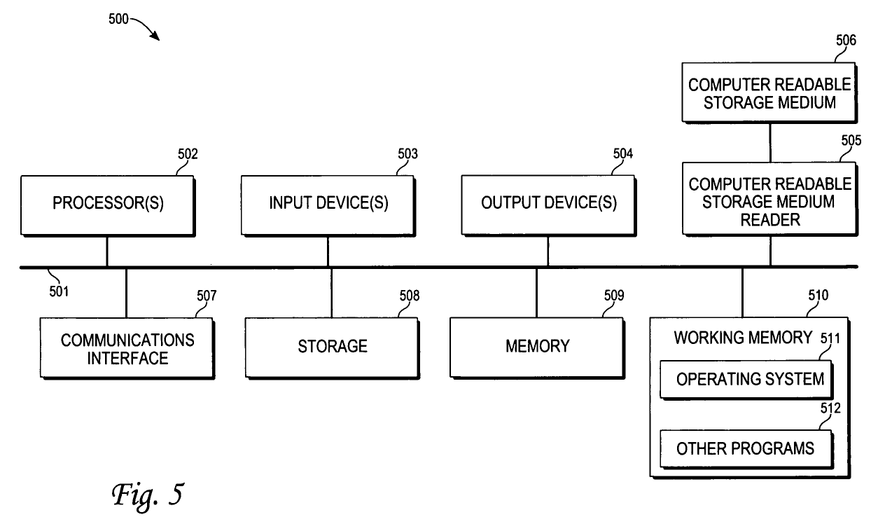

FIG. 5 illustrates an exemplary processing system 500, which can comprise one or more of the elements of FIGS. 1A and 1B. Turning now to FIG. 5, an exemplary computing system is illustrated that may comprise one or more of the components of FIGS. 1A and 1B. While other alternatives might be utilized, it will be presumed for clarity sake that components of the systems of FIGS. 1A and 1B are implemented in hardware, software or some combination by one or more computing systems consistent therewith, unless otherwise indicated.

Computing system 500 comprises components coupled via one or more communication channels (e.g., bus 501) including one or more general or special purpose processors 502, such as a Pentium®, Centrino®, Power PC®, digital signal processor (“DSP”), and so on. System 500 components also include one or more input devices 503 (such as a mouse, keyboard, microphone, pen, and so on), and one or more output devices 504, such as a suitable display, speakers, actuators, and so on, in accordance with a particular application. (It will be appreciated that input or output devices can also similarly include more specialized devices or hardware/software device enhancements suitable for use by the mentally or physically challenged.)

System 500 also includes a computer readable storage media reader 505 coupled to a computer readable storage medium 506, such as a storage/memory device or hard or removable storage/memory media; such devices or media are further indicated separately as storage 508 and memory 509, which may include hard disk variants, floppy/compact disk variants, digital versatile disk (“DVD”) variants, smart cards, read only memory, random access memory, cache memory, and so on, in accordance with the requirements of a particular application. One or more suitable communication interfaces 507 may also be included, such as a modem, DSL, infrared, RF or other suitable transceiver, and so on for providing inter-device communication directly or via one or more suitable private or public networks or other components that may include but are not limited to those already discussed.

Working memory 510 further includes operating system (“OS”) 511 elements and other programs 512, such as one or more of application programs, mobile code, data, and so on for implementing system 500 components that might be stored or loaded therein during use. The particular OS or OSs may vary in accordance with a particular device, features or other aspects in accordance with a particular application (e.g. Windows, WindowsCE, Mac, Linux, Unix or Palm OS variants, a cell phone OS, a proprietary OS, Symbian, and so on). Various programming languages or other tools can also be utilized, such as those compatible with C variants (e.g., C++, C#), the Java 2 Platform, Enterprise Edition (“J2EE”) or other programming languages in accordance with the requirements of a particular application. Other programs 512 may further, for example, include one or more of activity systems, education managers, education integrators, or interface, security, other synchronization, other browser or groupware code, and so on, including but not limited to those discussed elsewhere herein.

When implemented in software (e.g. as an application program, object, agent, downloadable, servlet, and so on in whole or part), a learning integration system or other component may be communicated transitionally or more persistently from local or remote storage to memory (SRAM, cache memory, etc.) for execution, or another suitable mechanism can be utilized, and components may be implemented in compiled or interpretive form. Input, intermediate or resulting data or functional elements may further reside more transitionally or more persistently in a storage media, cache or other volatile or non-volatile memory, (e.g., storage device 508 or memory 509) in accordance with a particular application.

Other features, aspects and objects of the invention can be obtained from a review of the figures and the claims. It is to be understood that other embodiments of the invention can be developed and fall within the spirit and scope of the invention and claims. The foregoing description of preferred embodiments of the present invention has been provided for the purposes of illustration and description. It is not intended to be exhaustive or to limit the invention to the precise forms disclosed. Many modifications and variations will be apparent to the practitioner skilled in the art. The embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the following claims and their equivalence.

1. A method for accessing a service, the method comprising:
receiving, from a requestor, a request to access at least one service and a filter indicating a query to be applied to a result returned by the at least one service;
accessing the at least one service on behalf of the requestor;
receiving a result set from the at least one service responsive to the accessing; and
providing, to the requester, a filtered result set by applying the filter to the result set received from the at least one service, wherein the filtered result set is mapped to a view associated with the requestor.

2. The method of claim 1, wherein providing, to the requestor, the filtered result set further comprises:
forming the filtered result set by applying the query to the result set received from the service.

3. The method of claim 2, wherein forming the filtered result set by applying the query to the result set received from the service further comprises at least one of:
filtering, alphabetizing, numerical ordering, sort ordering and truncating the result set in accordance with the filter.

4. The method of claim 1, wherein the service includes a computer resident application capable of providing services to a requestor or other recipient.

5. The method of claim 1, wherein the service includes at least one of: a network based application, a web based server resident application, a web portal, a search engine, a photographic, audio or video information storage application, an e-Commerce application, a backup or other storage application, a sales/revenue planning, marketing, forecasting, accounting, inventory management applications or other business application.

6. The method of claim 1, wherein filter includes a mechanism for informing a computational entity of a need, desire or request by a user, which may be human or a computational entity.

7. A method for receiving data, the method comprising:
sending to a server a request to access at least one service and a filter indicating a query to be applied to a result returned by the at least one service; and
receiving, from the server, a result set from the at least one service responsive to the request, wherein the result set is filtered according to the query, and wherein the result set is mapped to a view associated with the requestor.

8. The method of claim 7, wherein sending to a server a request to access a service and a filter indicating a query to be applied to a result returned by the service further comprises:
sending to a server a query indicating that the result is to be at least one of filtered, alphabetized, numerically ordered, sort ordered and truncated.

9. The method of claim 1, wherein:
the receiving step includes receiving, from a requestor, a request for information from a plurality of services and a filter indicating a query to be applied to a result received from the plurality of services;
the accessing step includes accessing a first database associated with a first service and accessing a second database associated with a second service;
the receiving step includes receiving a first result set from the first service and receiving a second result set from the second service; and
the providing step includes providing, to the requester, a result set comprising content selected from the first result set and the second result set in accordance with the filter, wherein the result set is provided to the requestor is mapped to a view associated with the requestor.

10. The method of claim 9, wherein at least one of the first database and the second database is a non-SQL format database.

11. The method of claim 1 provided on a computer-readable medium carrying one or more sequences of instructions for accessing a service, which instructions, when executed by one or more processors, cause the one or more processors to carry out the steps of claim 1.

12. The computer-readable medium as recited in claim 11, wherein the instructions for providing, to the requestor, the filtered result set further comprise instructions for carrying out the steps of:
forming the filtered result set by applying the query to the result set received from the service.

13. The computer-readable medium as recited in claim 11, wherein the instructions for providing, to the requester, the filtered result set further comprise instructions for carrying out the steps of:
providing the result set in the preferred format substantially independently of hard-coded routines for each anticipated preferred format in each service.

14. The computer-readable medium as recited in claim 11, wherein the service includes a computer resident application capable of providing services to a requestor or other recipient.

15. The computer-readable medium as recited in claim 14, wherein the service includes at least one of: a network based application, a web based server resident application, a web portal, a search engine, a photographic, audio or video information storage application, an e-Commerce application, a backup or other storage application, a sales/revenue planning, marketing, forecasting, accounting, inventory management applications or other business application.

16. The computer-readable medium as recited in claim 11, wherein filter includes any mechanism for informing a computational entity of a need, desire or request by a user, which may be human or a computational entity.

17. The method of claim 7 provided on a computer-readable medium carrying one or more sequences of instructions for receiving data, which instructions, when executed by one or more processors, cause the one or more processors to carry out the steps of claim 7.

18. The computer-readable medium as recited in claim 17, wherein the instructions for sending to a server a request to access a service and a filter indicating a query to be applied to a result returned by the service further comprise instructions for carrying out the steps of:
sending to a server a query indicating that the result is to be at least one of filtered, alphabetized, numerically ordered, sort ordered and truncated.

19. The method of claim 9 provided on a computer-readable medium carrying one or more sequences of instructions for accessing a service, which instructions, when executed by one or more processors, cause the one or more processors to carry out the steps of claim 9.

20. The computer-readable medium as recited in claim 19, wherein at least one of the first database and the second database is a non-SQL format database.

21. A proxy server, comprising:
a processor; and
one or more stored sequences of instructions which, when executed by the processor, cause the processor to carry out the steps of:
receiving, from a requester, a request to access at least one service and a filter indicating a query to be applied to a result returned by the at least one service;
accessing the at least one service on behalf of the requestor;
receiving a result set from the at least one service responsive to the accessing; and
providing, to the requestor, a filtered result set by applying the filter to the result set received from the at least one service, wherein the filtered result set is mapped to a view associated with the requester.

22. A client, comprising:
a processor; and
one or more stored sequences of instructions which, when executed by the processor, cause the processor to carry out the steps of:
sending to a server a request to access at least one service and a filter indicating a query to be applied to a result returned by the at least one service; and
receiving, from the server, a result set from the at least one service responsive to the request, wherein the result set is filtered according to the query, and wherein the result set is mapped to a view associated with the requestor.
